(19) United States
(12) Patent Application Publication
(10) Pub. No.: US 2008/0028792 A1
(43) Pub. Date: Feb. 7, 2008

(54) Method for Manufacturing an Optical Component

(75) Inventors: Juergen Ihlemann, Gottingen (DE); Malte Schulz-Ruhtenberg, Muenster (DE); Joerg Heber, Erfurt (DE)

Correspondence Address: AKERMAN SENTERFITT, P.O. BOX 3188, WEST PALM BEACH, FL, 33402-3188, US

(73) Assignees: LASER-LABORATORIUM GOETTINGEN E.V., 37077 GOETTINGEN GERMANY (DE); FRAUNHOFER GESELLSCHAFT ZUR FORDERUNG DE ANGERWAND FORSBURG E.V. HANSASTRASSE 27, GERMANY (DE)

(21) Appl. No.: 10/592,226

(22) PCT Filed: Mar. 24, 2005
(86) PCT No.: PCT/EP05/03134

§ 371 Date: Jul. 2, 2007

(30) Foreign Application Priority Data
Mar. 27, 2004 (DE) 10-2004-015-142.3

(51) Int. Cl. G02B 5/18; C03C 23/00

(52) U.S. Cl. 65/60.1

(57) ABSTRACT

A method for manufacturing an optical component in which an optical function of the component is created for electromagnetic radiation in an application wavelength range, using laser machining with laser radiation in a machining wavelength range, characterized in that the following steps are carried out:
1) A solid body is provided that is made from a material that in the raw state absorbs the laser radiation in the machining wavelength range,
2) Laser machining is carried out on the solid body employing one or more machining steps and
3) The material of the solid body is transformed into a final state in which the solid body is transparent to the electromagnetic radiation in the application wavelength range and thus fulfills the intended optical function.

A method whereby, in order to produce a stepped profile on an optical component a machining cycle is carried out several times, consisting of a step in which an absorption layer is deposited and also consisting of a laser ablation step, and whereby at least once a material transformation step is carried out in which the profile produced is transformed into a final state that is transparent to an application wavelength range.

A method whereby firstly a multi-layer system is applied, and then an ablation step is carried out several times and finally a material transformation step is performed.

### CROSS REFERENCE TO RELATED APPLICATION

This application is a national stage of PCT/EP2005/003134 filed on Mar. 24, 2005 and based upon application Ser. No. 10 2004 015 142.3 filed Mar. 27, 2004 under the International Convention.

### BACKGROUND OF THE INVENTION

1. Field of the Invention

The invention relates to a method for manufacturing an optical component in which an optical function of the component for electromagnetic radiation in an application wavelength range is produced by means of laser machining using laser radiation in a machining wavelength range.

2. Description of Related Art

Micromaterial machining by means of lasers is used for various applications in the fields of optics, mechanics, flow technology and electronics. The drilling of microholes in circuit boards or inkjet heads, the trimming of electrical components, the stripping of insulation from wires, or the manufacture of medical stents are examples of this technique. When manufacturing finely structured optical components, for example those components which are required for beam guidance and beam homogenization in these applications, the precision of the machining depends closely on the optical absorption capacity at the corresponding laser wavelength. Only highly absorbent material can be machined with high precision. In particular, a high absorption capacity of the material to be machined is required in order to produce a specific profile and/or a specific structure by means of laser ablation. In the process, the desired structure, for example a mask, is produced by ablating the material at the irradiated sites. On the other hand, as intended, optical glasses and other optical materials (crystals) are only weakly absorbent in the optical spectral range, i.e. at wavelengths from the visible to the ultraviolet (UV), and therefore cannot be machined with a high degree of precision by lasers which emit in this spectral range.

### SUMMARY OF THE INVENTION

There is a particularly important and growing need for functional UV optics, for example diffractive optical elements (phase elements, amplitude elements) to shape and homogenize the beam of pulsed UV excimer lasers, which are predestined to be used for micromaterial machining. Because these optical components are required to be transparent in particular for the typical wavelengths (193 nm, 248 nm) of the excimer lasers, only shorter wavelengths (157 nm), for which the optical material, e.g. quartz glass, is adequately absorbent, can be used for manufacturing these optical components. However, it is very difficult and complicated to perform machining at such extremely short wavelengths. In addition, the use of the optical components produced in this way is always limited to higher application wavelengths than the machining wavelength. Therefore, laser ablation has not yet established itself as an optical manufacturing tool, although it has advantages to offer in particular for the manufacture of miniaturized, complex-shaped optical elements compared with classical (mechanical grinding and polishing) or lithographic manufacturing techniques. In particular, the manufacturing of individual items or of small production runs is very costly in terms of time and money, and the manufacturing process, due to the many different steps involved in the lithographic processes (coating, exposure, development, etching), is very complex, and flexibility for producing shapes is also limited. In particular, in contrast to lithographic methods, laser machining can also be used without any problems on curved surfaces.

DE 100 17 614 A1 discloses a method for the manufacture of a dielectric reflection mask in which, prior to carrying out the structure-producing laser irradiation of the component, a layer that absorbs the machining wavelength is arranged between a substrate and a reflection mask coating system consisting of alternating layers having high and low refractive indexes. Following the structure-producing ablation of the absorption layer, remains of the absorption layer that have not been removed may be left behind at the irradiated sites and these may undesirably impair the transparency of the mask for the application wavelength. In a subsequent material transformation step these residues can then be transformed into a transparent material in order to improve the mask transmission.

The prior art method has the advantage that when a reflection mask is produced the application wavelength does not have to be restricted to wavelengths greater than the machining wavelength; however, it is disadvantageous that an optical function of the component can only be achieved in cooperation with the previously applied mask layer. On the other hand, the absorption layer is effective only when the mask is produced. The method is also only suitable for rear-side ablation from the substrate side. This method is rather unsuitable for manufacturing other components, in particular those with multi-level profiles, which are required for many applications.

The purpose of the present invention is therefore to propose a laser machining method for manufacturing an optical component for electromagnetic radiation. The method allows the application wavelength of the electromagnetic radiation that is to be used to be selected independently of the machining wavelength of the laser radiation; it permits single and multi-level profiles to be produced on the component, and it can be flexibly applied to various types of components with the option of machining the front and/or rear sides.

This task is solved in conjunction with the precharacterizing clause of claim 1 by carrying out the following steps:
1) Provide a solid body made of a material which, in the raw state, absorbs the laser radiation in the machining wavelength range,
2) Perform laser machining of the solid body using one or more machining steps, and
3) Transform the material of the solid body into a final state that fulfills the intended optical function, a state in which the solid body is transparent to the electromagnetic radiation in the application wavelength range.

By means of the method according to the invention, a process is made available that permits the laser machining (surface structuring) of the component to be performed in an adequately absorbing state in order to produce the optical function. Once the component has been given its final shape, it is transformed into a transparent state in order to enable the optical function to be performed, for which purpose a material is used whose absorption/transmission characteristics can be modified over a wide range by a material transformation process that leaves the shape unchanged.

Because the laser machining is carried out on a solid body which, in an initial state, absorbs the wavelength of the machining laser and which, in a final state, following material transformation, is transparent in the application wavelength range, it is possible to manufacture an optical component for wavelengths that are independent of the machining wavelength, without having to apply an absorbing layer because, in its raw state, the solid body itself possesses the absorption capability. This is a very cost-effective and time-saving factor. In particular, the machining wavelength may lie within the (later) application wavelength range; for example, a machining wavelength and an application wavelength may each be 193 nm. The suitable starting materials usually exhibit a continuously declining absorption characteristic from short to long wavelengths and thus a correspondingly continuous decline in laser machinability as well as a continuous increase in their applicability as an optical element; consequently, when the component is being manufactured, it is also possible for intermediate states to occur which take account of these gradual changes in absorption/transmission. For example, the starting material may be strongly absorbent for a first wavelength in the machining wavelength range and moderately absorbent for a second wavelength, so that the absorption capacity is inadequate for precise machining at this second wavelength, while on the other hand it is still too high for the optical application. If the laser machining is carried out with the first wavelength, then, following transformation, the material may be highly transparent to the second wavelength and moderately absorbent for the first wavelength. That is to say that, when the material is transformed, a certain degree of transmission (in the ideal case all the way through to total transparency) is achieved in the machining wavelength range, depending on the machining wavelength. In each case, in the initial state of the component it is vital to have sufficient absorption of the machining wavelength in order to achieve precise machining, and in the final state it is important to have sufficient transparency for the desired application wavelength(s) in order to fulfill the optical function.

When the material is transformed, the entire solid body becomes transparent to the application wavelength range. Following the transformation of the material, i.e. in the transparent state, the areas which are irradiated, i.e. ablated during structure-forming ablation on a surface of the solid body, and the non-irradiated areas cooperate in their optical function. For this purpose, the material transformation step is applied to the irradiated and the non-irradiated areas. Laser machining of the solid body is particularly suitable for removing coatings over relatively large areas, but also for creating structured patterns. By adjusting the pulse energies and the pulse counts, multi-level profiles (surface reliefs) can be produced in particular when using UV pulsed lasers, e.g. excimer lasers having the wavelengths of 193 nm and 248 nm, which are particularly suitable for micromaterial machining.

In order to produce a multi-level structure, the surface of the component is irradiated preferably pixel by pixel in sequential machining steps. In this case, for example, a standard pulse energy, or pulse energy density (fluence) is selected and the number of pulses is varied. The fluence is adjusted in such a way that the material is removed down to a certain depth. A multi-level profile can then be obtained by selecting different pulse counts at different irradiation sites. In particular, to produce a two-level profile, i.e. a structure with two different relief levels (the non-ablated plane and an ablated plane), it is particularly advantageous, because of the considerable amount of time saved, to perform simultaneous structure-forming irradiation of the entire surface using an imaging element that contains the structure, e.g. via a so-called master mask. Levels are understood as macroscopic to infinitesimally small ablations, so that quasi continuous profiles can also be produced.

In order to simplify handling, the solid body may be mounted on a preferably transparent carrier body that may also be part of the finished optical component.

SiOx is suitable as the initial material for the solid body, in particular for use with UV lasers. The SiOx material where 1<x<2, is a non-stoichiometric silicon oxide compound (a partially oxidized, but macroscopically homogeneous material) which strongly absorbs UV radiation. On the other hand, in the form of SiO₂ (fully oxidized material) the material is highly transparent to UV radiation and in addition possesses a high destruction threshold, so that it is suitable for high energy densities. The material can be transformed by heating it in an oxidizing atmosphere (for example in air) using a suitable apparatus. In this process the SiOₓ is transformed into SiO₂. It has been shown in test series that the thermal transformation of material (oxidation) of an SiOₓ component in air for about eight to nine hours at approximately 900° C. is particularly effective. This treatment method allows a particularly high transparency (intrinsic transparency>90% for 193 nm) to be achieved. Shorter oxidation times and/or lower temperatures yield poorer transparency values, and no significant further improvement can be achieved at longer oxidation times and /or higher temperatures. In principle, photochemical oxidation is also possible by carrying out laser irradiation over an area or locally resolved, below the ablation threshold, in an oxidizing atmosphere, with or without further thermal treatment. It is also conceivable to specifically transform material with local resolution, as a result of which even more possibilities for producing optical structures (also independently of removing material) are provided.

In principle, the method can also be used with other materials in the visible or even in the infrared spectral range. The types of material which in principle can be used are oxidic materials such as metal oxides and semiconductor oxides. In addition to silicon oxide (SiOₓ), materials such as aluminium oxide, scandium oxide, hafnium oxide and yttrium oxide are especially suitable for the UV wavelength range. Tantalum oxide and titanium oxide are particularly suitable for the visible spectral range.

The above-mentioned task is also solved in accordance with the invention, in conjunction with the precharacterizing clause of claim 4, by producing a stepped profile on the component by passing it several times through a machining cycle consisting in each case of a deposition step, in which an absorption layer that in a raw state absorbs the machining wavelength range is applied to a substrate body that is transparent to the machining wavelength range, and also consisting of an ablation step in which the applied absorption layer is ablated at the irradiated sites, at least over part of the coating thickness, and furthermore by carrying out at least once a material transformation step in which the profile produced is transformed into a final state that is transparent to the application wavelength range.

Because a machining cycle consisting of deposition of a coating and structure-forming ablation is carried out several times, it is possible to produce a stepped component with more than two levels. This is particularly advantageous when manufacturing diffractive phase elements (DPE) because multi-level (e.g. 4-, 8-, 16-level) DPEs possess greater diffractive efficiency. When the laser energy density, the pulse count and the coating thickness are appropriately set, it is possible to adjust the ablation over the entire thickness of the ablation layer down to the substrate; consequently, the respective interface between the substrate and the absorption layer can be used as a “pre-set breaking point”. This interface makes it easier to free a substrate from a coating layer uniformly and cleanly (with a high surface quality) in a defined area. Thus, compared with machining a solid body, or in the case when the absorption layer is removed only over part of the layer thickness, much greater accuracy (with regard to the step height) can be achieved with the structure-producing laser machining. When a front side is ablated (irradiation directly on the absorption layer), it is possible in this way to produce a 2ⁿ-level element with n cycles. When ablation is carried out from the rear side (irradiation through the substrate) and correspondingly the entire layer system (that has been formed up to that point in time) is removed all the way down to the substrate, an n+1 level element can be produced by n exposures. For more complex structures it is conceivable also to use combinations of front-side and rear-side ablation. In principle, however, it is also conceivable to produce specific graduations within an absorption layer by controlling the irradiation energy so that at various points, only a certain portion of the layer thickness is removed. Deposition and ablation can be carried out on different apparatuses, but the laser ablation process can also be integrated into a deposition apparatus.

The above-mentioned task is also solved according to the invention, in conjunction with the precharacterizing clause of claim 7, by first applying a coating system consisting of double layers, comprising respectively a single layer that transmits the machining wavelength range, and a single layer that absorbs the machining wavelength range, onto a substrate body that is transparent to the machining wavelength range, and by then carrying out several times an ablation step in which, in order to produce a stepped profile on the component, in each case a double layer is ablated at the irradiated sites, and by carrying out a material transformation step in which the profile produced is transformed into a final state that is transparent to the application wavelength range.

Due to the arrangement of a (multiple) layer system consisting alternately of absorbing (e.g. SiOₓ) and transparent (e.g. SiO₂) layers of suitable thickness, a further possibility exists for producing a multi-level profiled optical component in which the application wavelength is independent of the machining wavelength. If, for ablation purposes, a fluence is set at which in each case one such double layer is ablated using front-side ablation, it is possible to produce a 2ⁿ-level element using n exposures, where one exposure may consist of one or more laser pulses per irradiation position.

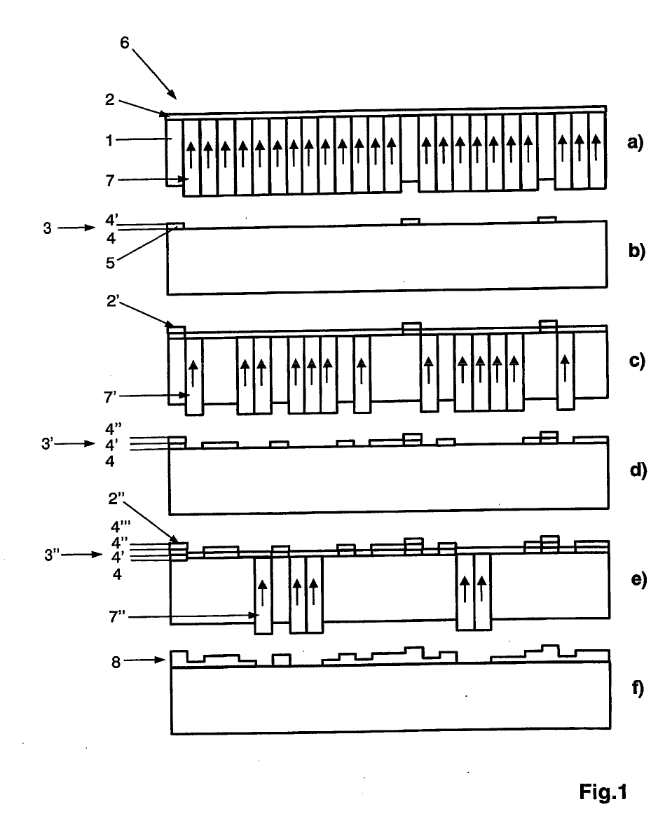

Further details of the invention may be derived from the following detailed description and the attached drawing, in which a preferred exemplary embodiment of the invention is depicted. FIG. 1 shows a diagram for producing a four-level diffractive phase element by means of multiple layer deposition and laser ablation.

A method for manufacturing an optical component 6 is based substantially on carrying out several times a machining cycle consisting of a deposition step in which an absorption layer is deposited, and also consisting of a structure-forming laser ablation step, said method being also based on a material transformation step in which the component 6 is transformed into a final state that is transparent to the laser radiation.

The method is explained using the example of a four-level diffractive phase element (DPE) for UV wavelengths. The way in which it works is based on the diffraction of light at a finely structured surface relief in an optical material. Through diffraction and interference of an incident electromagnetic wave, for example of a laser beam, on the DPE it is possible to bring about a desired intensity distribution in a so-called signal plane. In the case of DPEs, only the phase of the light wave is modulated, i.e. they accept practically all transmittive elements (on the other hand, diffractive amplitude elements (DAE) modulate the amplitude of the incident light wave, i.e. they are always associated with losses). For example, in this way, the beam profile of an excimer laser can be shaped and homogenized for a subsequent application. The necessary surface relief is calculated beforehand using an in principle known calculation algorithm, for example a computer-generated hologram. The total depth of the structure is given by the equation D=(q−1)/q×λ/(n−1), where q is the number of levels, i.e. q−1 is the number of steps, λ is the wavelength at which the DPE is intended to fulfill its optical function, and n is the diffractive index of the material of the DPE in air. For a four-level element for an application wavelength of, for example, 193 nm, the total structural depth is thus 258 nm at a diffractive index of n=1.561 and a respective step height of 86 nm.

On a substrate 1, advantageously formed as a quartz body, a first absorption layer 2 is applied by means of vapour deposition using a suitable, in principle known apparatus. Via a first (calculated) mask (not shown) the absorption layer 2 is then ablated down to the height of the substrate at the irradiated positions using laser radiation 7 (FIG. 1 a). Alternatively, machining may also be carried out by appropriately controlling the laser beam so that it scans pixel by pixel over the surface of the component 6. The laser energy required for ablation is adapted to the applied coating layer thickness and is selected in such a way that the absorption layer is completely removed without damaging the substrate 1. Machining is carried out on the substrate side, i.e. as a rear-side ablation. A UV excimer laser, for example, having a wavelength of 193 nm, i.e. the same wavelength that is intended for the later function of the DPE, is used for the laser ablation. The absorption layer 2 consists of an SiOₓ material that is highly absorbent at 193 nm. This first machining cycle results in a surface having a structure 3 with two relief levels 4, 4′, i.e. with a step 5 (FIG. 1b). A four-level element thus has four relief levels and three steps. A second machining cycle starts with the deposition of a second absorption layer 2′, which is vapour-deposited onto the structure 3 formed in the first cycle (FIG. 1c). Then a second ablation is carried out with a structure-forming laser beam 7′ (via a second mask, or pixel by pixel), thus creating the structure 3′ having three levels 4, 4′, 4″ (FIG. 1d). In a third machining cycle consisting of coating (deposition) and ablation, the structure 3″ with four levels 4, 4′, 4″, 4′″ is formed in similar fashion via an absorption layer 2″ using laser ablation 7″ (FIG. 1e). In a final thermal material transformation step (FIG. 1f), in which the component 6 is heated in an oven for several hours in air to several 100° C., the structural material SiOₓ is oxidized to SiO₂ and thus becomes transparent to the laser wavelength. As a result, the structure 3″ finally turns into a four-level transparent profile 8 that satisfies the desired optical function as a DPE for the operating wavelength.

If, instead of multiple ablation and deposition of an absorption layer, a solid body is machined, or the entire layer thickness is not removed, the pulse energy density and the pulse count of the laser are used to obtain defined step depths or a quasi continuous profile in the absorbing material. It is important here to set the above parameters and also the beam profile (laser beam characteristics) very accurately, possibly with the help of upstream optical elements, in order to achieve a high degree of accuracy, because there is no longer any (helpful) “preset breaking point” between the substrate and the absorption layer.

1. A method for manufacturing an optical component in which an optical function of the component is created for electromagnetic radiation in an application wavelength range, using laser machining with laser radiation in a machining wavelength range, comprising:
1) providing solid body made from a material that in a raw state absorbs the laser radiation in the machining wavelength range,
2) carrying out laser machining on the solid body, employing one or more machining steps and
3) transforming material of the solid body into a final state in which the solid body is transparent to the electromagnetic radiation in the application wavelength range and thus fulfills the intended optical function.

2. A method according to claim 1, wherein the material of the component is ablated down to a defined depth at the irradiated sites using a UV pulsed laser with a preset pulse energy density.

3. A method according to claim 2, wherein a stepped profile having an optional number of steps with defined step heights is produced on the component by respectively adjusting the pulse energy density and the number of pulses.

4. A method for manufacturing an optical component in which an optical function of the component is created for electromagnetic radiation in an application wavelength range, using laser machining with laser radiation in a machining wavelength range, wherein, in order to produce a stepped profile (8) of the component (6) a machining cycle is carried out several times, consisting in each case of a deposition step in which an absorption layer (2, 2′, 2″) that in a raw state absorbs the machining wavelength range is applied to a substrate body (1) that is transparent to the machining wavelength range, and also consisting of an ablation step in which the applied absorption layer (2, 2′, 2″) is ablated at the irradiated sites, at least over part of the layer thickness, and characterized also in that a material transformation step, in which the profile (8) produced is transformed into a final state that is transparent to the application wavelength, is carried out at least once.

5. A method according to claim 4, wherein after each machining cycle or after selected individual machining cycles the material transformation step is carried out for the respective absorption layer (2, 2′, 2″).

6. A method according to claim 4, wherein the machining cycles comprise front-side ablation steps in which the absorption layer is directly irradiated and/or rear-side ablation steps in which the absorption layer is irradiated through the substrate body (1).

7. A method for manufacturing an optical component in which an optical function of the component is created for electromagnetic radiation in an application wavelength range, using laser machining with laser radiation in a machining wavelength range, wherein first a system of coating layers consisting of double layers comprising, respectively, an individual layer that transmits the machining wavelength range and an individual layer that absorbs the machining wavelength range, is deposited onto a substrate body that is transparent to the machining wavelength range, and characterized also in that subsequently an ablation step, in which in each case a double layer is ablated at the irradiated sites in order to produce a stepped profile on the component, is carried out several times, and also characterized in that a material transformation step in which the profile produced is transformed into a transparent final state that is transparent to the application wavelength is carried out.

8. A method according to claim 1, wherein a non-stoichiometric SiOx compound at an average 1<x<2 is used as the raw material, and that the SiOₓ material is transformed by the material transformation step into a final state consisting of SiO₂.

9. A method according to claim 1, wherein the raw material is selected from a group of materials consisting of aluminium oxide, scandium oxide, hafnium oxide, yttrium oxide, tantalum oxide and titanium oxide.

10. A method according to claim 1, wherein the material transformation consists of an oxidation step carried out through thermal treatment of the component in an oxidizing atmosphere.

11. A method according to claim 10, wherein during thermal oxidation the component is exposed for eight to nine hours to a temperature of approximately 900° C.

12. A method according to claim 1, wherein by irradiating the component with a laser beam in an oxidizing atmosphere the irradiated material is photochemically transformed, at least in partial areas.

13. A method according to claim 1, wherein the machining of the component takes place by irradiating the machined area pixel by pixel in sequential steps or by carrying out the machining over the entire area using at least one imaging element.
